(19) United States
(12) Patent Application Publication
(10) Pub. No.: US 2003/0058655 A1
(43) Pub. Date: Mar. 27, 2003

(54) REAR LIGHT OF MOTOR VEHICLE

(76) Inventor: Yung-Yi Chuang, Taipei (TW)

Correspondence Address: BACON & THOMAS, PLLC, 625 SLATERS LANE, FOURTH FLOOR, ALEXANDRIA, VA, 22314

(21) Appl. No.: 09/962,156

(22) Filed: Sep. 26, 2001

(51) Int. Cl. F21V 5/00

(52) U.S. Cl. 362/521; 362/545; 362/244; 362/331; 362/333

(57) ABSTRACT

A rear light of motor vehicle enclosed in a housing comprising a printed circuit board (PCB) on a bottom housing and a plurality of light emitting diodes (LEDs) formed thereon and electrically coupled to the PCB for emitting light thereby; and convergent lens means atop the LEDs whereby light emitted from the LEDs are brought together by the convergent lens means to form uniform and focused light on a first predetermined area, such focused light is further focused on a second predetermined area by rectangular refractive members in an upper housing.

### FIELD OF THE INVENTION

The present invention relates to rear light of motor vehicle and more particularly to such a rear light formed of convergent lenses with improved characteristics.

### BACKGROUND OF THE INVENTION

Semiconductor and optoelectronics have known a rapid and a spectacular development leading to a continuous increase of brightness emitted by a light emitting diode (LED). LED also has the advantage of low power consumption. Hence, recently LEDs have been used for manufacturing rear light by the manufacturers. However, rear light implemented by LEDs has several disadvantages. For example, emitted light is non-uniform in different angles. Further, brightness of one angle may be several times brighter than that of another angle. In fact, light is diffused from rear light rather than uniformly emitted. As a result, a lit rear light may not be seen clearly by a distant viewer. Hence, even LEDs have the advantage of low power consumption there is still a bottleneck in implementing a rear light formed of LEDs. Thus improvement exists.

### SUMMARY OF THE INVENTION

It is therefore an object of the present invention to provide a rear light of motor vehicle enclosed in a housing comprising a printed circuit board (PCB) on a bottom of the housing and a plurality of light emitting diodes (LEDs) formed thereon and electrically coupled to the PCB for emitting light thereby; and convergent lens means atop the LEDs whereby light emitted from the LEDs are brought together by the convergent lens means to form uniform, focused light on a predetermined area. Hence, a lit rear light can be seen clearly by distant viewers.

It is another object of the present invention to provide a transparent upper housing together with a bottom board to form the housing so as to prevent foreign objects from entering the housing.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of rear light of motor vehicle according to the invention;

FIG. 2 is an exploded view of the FIG. 1 rear light;

FIG. 3 is a top plan view of convergent lens device of FIG. 2;

FIG. 4 is a bottom plan view of convergent lens device of FIG. 2; and

FIG. 5 is a cross-sectional view of another preferred embodiment of convergent lens device according to the invention.

### DETAILED DESCRIPTION OF THE PREFERRED EMBODIMENTS

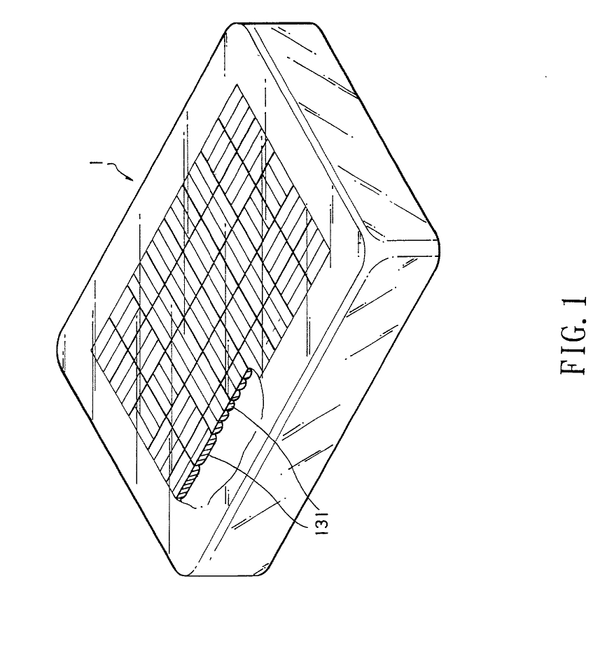

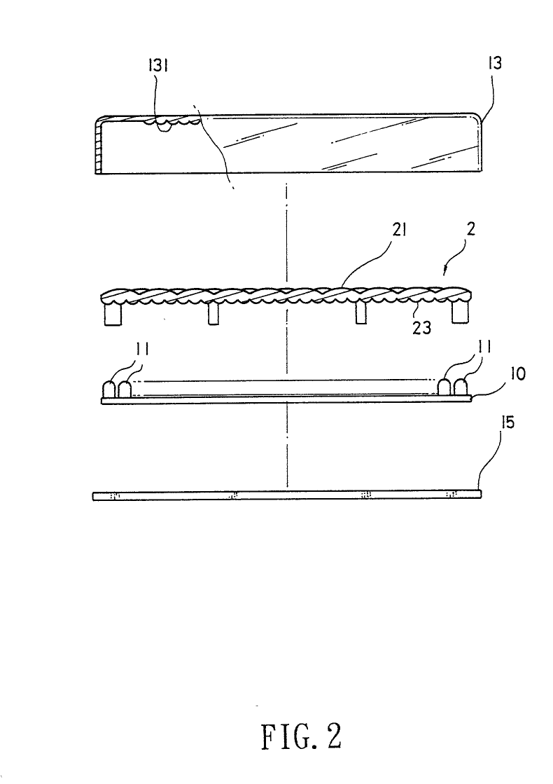

Referring to FIGS. 1 and 2, there is shown a parallelepiped rear light of motor vehicle constructed in accordance with the invention. The rear light is enclosed in a housing 1 comprising a printed circuit board (PCB) 10 on the bottom, a plurality of LEDs 11 formed on and electrically coupled to PCB 10 for emitting light thereby, a convergent lens device 2 atop LEDs 11, a transparent upper housing 13 having a plurality of rectangular refractive members 131 wherein rectangular refractive members 131 in a cross shaped portion thereof are disposed longitudinally and rectangular refractive members 131 in four corners are disposed transversely, each of rectangular refractive members 131 having a curvature of 5 m/m for bringing together light on a first predetermined area, upper housing 13 being capable of preventing foreign objects (e.g., dust) from entering housing 1, and a bottom board 15 fitted together with upper housing 13 to form a complete housing 1.

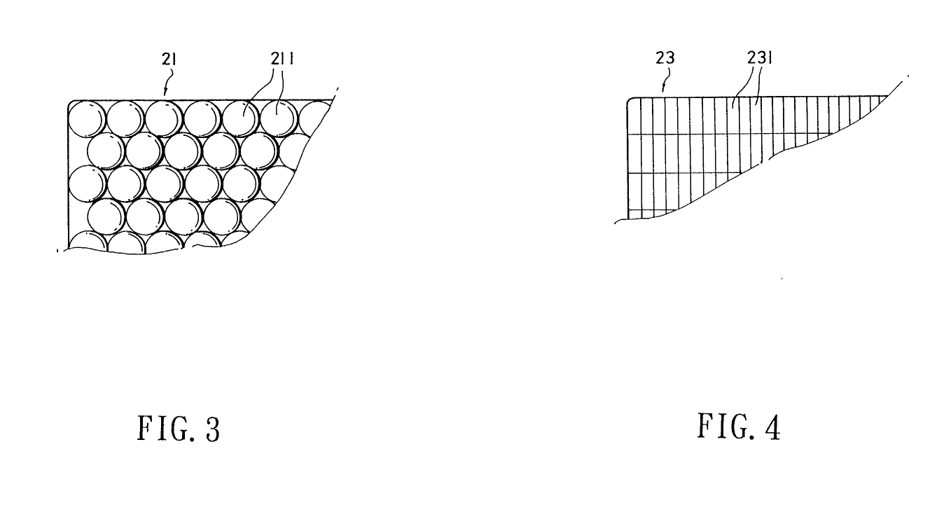

Referring to FIGS. 2, 3 and 4, convergent lens device 2 comprises a top convergent lens assembly 21 and a bottom auxiliary lens assembly 23. Convergent lens assembly 21 comprises a plurality of rows of round convergent lenses 211 each having a curvature of 10 m/m abutted together wherein round convergent lenses 211 belonging to the same row having centers on a virtual straight line. Auxiliary lens assembly 23 comprises a plurality of rows of rectangular lenses 231 each having a curvature of 3 m/m being capable of bringing together light on a first predetermined area.

Preferably, a distance from light source to convergent lens device 2 is 15.3 cm (i.e., optimum focal length of convergent lens device 2) which is obtained by employing the following equation:

1/f=c×n((1/R1)-(1/R2))

where f is a focal length of round convergent lens 211, c is a constant, n is a refractive index of round convergent lens 211, R1 is curvature of round convergent lens 211, and R2 is curvature of rectangular lens 231. At such optimum focal length, light emitted from LEDs 11 is uniform and focused on a desired area.

By utilizing above construction, it is possible of emitting light from LEDs 11 (i.e., diffused light) by the activation of PCB 10. Such light are then brought together by convergent lens device 2 (i.e., parallel beams of light are focused on first predetermined area). Thereafter, such focused light is further focused on a second predetermined area by rectangular refractive members 131 in upper housing 13 (i.e., finally emitted light). As a result, a lit rear light may be seen clearly by distant viewers e.g., pedestrians or drivers. This can reduce the possibility of traffic accidents.

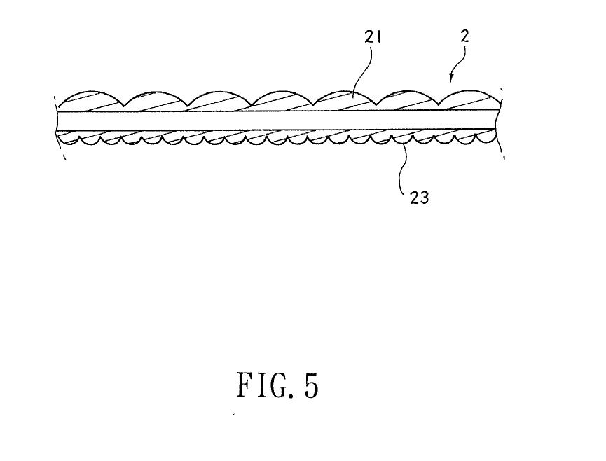

Referring to FIG. 5, there is shown another preferred embodiment of convergent lens device 2 according to the invention wherein convergent lens assembly 21 is equally spaced apart from auxiliary lens assembly 23 (i.e., parallel).

While the invention has been described by means of specific embodiments, numerous modifications and variations could be made thereto by those skilled in the art without departing from the scope and spirit of the invention set forth in the claims.

What is claimed is:

1. A rear light of motor vehicle enclosed in a housing comprising:
a printed circuit board (PCB) on a bottom of the housing and a plurality of light emitting diodes (LEDs) formed thereon and electrically coupled to the PCB for emitting light thereby;
convergent lens means atop the LEDs including a convergent lens assembly and an auxiliary lens assembly wherein the convergent lens assembly comprises a plurality of rows of round convergent lenses having a curvature of 10 m/m abutted together wherein the convergent lenses of the same row having centers on a straight line and the auxiliary lens assembly comprises a plurality of rows of rectangular lenses having a curvature of 3 m/m being capable of bringing together light on a first predetermined area;;
a transparent upper housing having a plurality of rectangular refractive members disposed in a predetermined shape, each of the refractive members having a curvature of 5 m/m for bringing together light on a second predetermined area; and
a bottom board fitted together with the upper housing to form the housing;
whereby light emitted from the LEDs are brought together by the convergent lens means and the refractive members to form uniform, focused light on the second predetermined area.

2. The rear light of claim 1, wherein the convergent lens assembly is equally spaced apart from the auxiliary lens assembly.
